(19) United States
(12) Patent Application Publication
(10) Pub. No.: US 2014/0365028 A1
(43) Pub. Date: Dec. 11, 2014

(54) VEHICLE DATA COLLECTING SYSTEM

(71) Applicant: Hyundai Motor Company, Seoul (KR)

(72) Inventors: Dong Youl LEE, Seoul (KR); Chul Min KIM, Suwon-si (KR); Young Su KIM, Yongin-si (KR); Kwang Chul JEONG, Bucheon-si (KR)

(73) Assignee: HYUNDAI MOTOR COMPANY, Seoul (KR)

(21) Appl. No.: 14/101,106

(22) Filed: Dec. 9, 2013

(30) Foreign Application Priority Data
Jun. 7, 2013 (KR) 10-2013-0065192

(51) Int. Cl. G07C 5/00

(52) U.S. Cl. CPC G07C 5/008
USPC 701/1

(57) ABSTRACT

A vehicle data collecting apparatus includes a file receiver for receiving an extensible markup language (XML) script file, an XML parser for extracting data format information for each vehicle model and network by parsing the XML script file received. A controller is configured to control a data collector so as to collect vehicle data base on the data format information extracted and the data collector collects the vehicle data through the controller. The vehicle data collecting system may flexibly collect vehicle data regardless of a data format which depends on a vehicle model and vehicle network by collecting the vehicle data based on the extensible markup language (XML) script file generated by a managing server.

### CROSS-REFERENCE TO RELATED APPLICATION

This application claims the benefit of priority to Korean Patent Application No. 10-2013-0065192, filed on Jun. 7, 2013 in the Korean Intellectual Property Office, the disclosure of which is incorporated herein in its entirety by reference.

### TECHNICAL FIELD

The present disclosure relates to a vehicle data collecting system, and more particularly, to a technology of collecting vehicle data based on a script file having an extensible markup language (XML) type.

### BACKGROUND

In general, an electronic system of a vehicle is classified into an electrical system (e.g., a sensor and a controller) and an information system (e.g., an infotainment and a telematics). Vehicle information includes a vehicle network, such as, controller area network (CAN), local interconnect network (LIN), FlexRay, and MOST data generated by the controller and the sensor of the electrical system in the vehicle. Contents and device manipulation information are generated by an audio, a video, a navigation, and telematics of the information system.

A minimum unit of the above mentioned vehicle information is a signal having a functional mean on a generator (e.g., the controller). Signal data is bit-field digital data compressed in a hexadecimal form having a length of 1 bit through several bits.

Formats of meaningful data generated from the vehicle network, the sensor, or the like are different depending on vehicle model and network. The meaningful data includes an ignition key state, an engine speed sensor failure state, a fuel injection stop state, a torque calibration state, an air conditioner compressor activation state, an engine torque ratio, an engine speed, a vehicle speed, and the like.

Therefore, a data collecting code needs to be corrected one by one in a data extraction algorithm of a data collection apparatus for each vehicle to correspond to the data format according to the vehicle model and network. This increases time and cost in developing and maintaining the data collecting apparatus.

### SUMMARY

The present disclosure has been made to solve the above-mentioned problems occurring in the prior art while advantages achieved by the prior art are maintained intact.

An aspect of the present disclosure provides a managing server generating a script file having an extensible markup language (XML) file including information for a data format for each vehicle model and vehicle network.

Another aspect of the present disclosure provides a vehicle data collecting apparatus capable of flexibly collecting vehicle data regardless of the data format which depends on a vehicle model and vehicle network, by collecting the vehicle data based on the script file having the XML file.

According to an embodiment of the present disclosure, a vehicle data collecting apparatus includes a file receiver for receiving an extensible markup language (XML) script file, and an XML parser for extracting data format information for each vehicle model and vehicle network by parsing the XML script file received by the file receiver. A controller is configured to control a data collector so as to collect vehicle data based on the data format information extracted by the XML parser, and the data collector collects the vehicle data under control of the controller.

According to another embodiment of the present disclosure, a managing server includes a script file generator for generating a script file based on vehicle network information and vehicle model information. An extensible markup language (XML) transformer transforms the script file generated by the script file generator into an XML file, and a file transmitter transmits the XML script file transformed by the XML transformer to a vehicle data collecting apparatus.

According to another embodiment of the present disclosure, a vehicle data collecting system includes a managing server for generating a script file based on vehicle network information and vehicle model information and then transforming the script file into an extensible markup language (XML) file to generate an XML script file. A vehicle data collecting apparatus extracts information for a data format for each vehicle model and vehicle network by parsing the XML script file generated by the managing server and then collects vehicle data based on the extracted information.

### BRIEF DESCRIPTION OF THE DRAWINGS

The above and other objects, features and advantages of the present disclosure will be more apparent from the following detailed description taken in conjunction with the accompanying drawings.

FIG. 1 is a configuration diagram of a vehicle data collecting system according to an exemplary embodiment of the present disclosure.

FIG. 2 is a configuration diagram of a vehicle data collecting apparatus according to an exemplary embodiment of the present disclosure.

FIG. 3 is a flow chart of a vehicle data collecting method according to an exemplary embodiment of the present disclosure.

### DETAILED DESCRIPTION

Hereinafter, exemplary embodiments of the present disclosure will be described in detail with reference to the accompanying drawings.

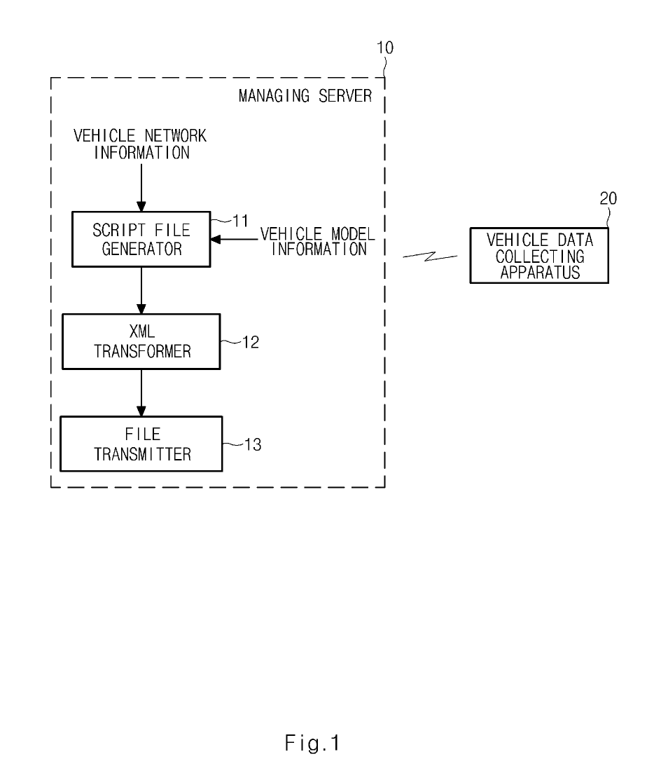

FIG. 1 is a configuration diagram of a vehicle data collecting system according to an exemplary embodiment of the present disclosure. As shown in FIG. 1, the vehicle data collecting system according to an exemplary embodiment of the present disclosure includes a managing server 10 and a vehicle data collecting apparatus 20 mounted on each vehicle.

The managing server 10, which is a server transmitting an extensible markup language (XML) script to the vehicle, includes a script file generator 11, an XML transformer 12, and a file transmitter 13.

The script file generator 11 generates a script file based on vehicle network information and vehicle model information. The script file includes information for a data format for each vehicle model and vehicle network used for collecting the vehicle data.

In addition, the vehicle network information includes a controller area network (CAN) of a database for CAN format, a local interconnect network (LIN) of a LIN description files format, a FlexRay of a field bus exchange format, and the like.

The XML transformer 12 transforms the script file generated from the file generator 11 into an XML file. The file transmitter transmits the XML script file transformed by the XML transformer 12 to the vehicle data collecting apparatus 20. In this case, the file transmitter 13 transmits the XML script file in a push scheme, as an example.

The vehicle data collecting apparatus 20 is mounted on each vehicle to collect the vehicle data. Since the vehicle data formats are different for each vehicle model and vehicle network, the vehicle data collecting apparatus 20 may collect the vehicle data when the data format of the corresponding vehicle is known.

The vehicle data collecting apparatus 20 receives the XML script file including data format information for each vehicle model and vehicle network from the managing server 10 and then collects the vehicle data based on the received XML script file. Therefore, the vehicle data collecting apparatus 20 may be mounted on any vehicle model and vehicle network so as to normally collect data of the corresponding vehicle.

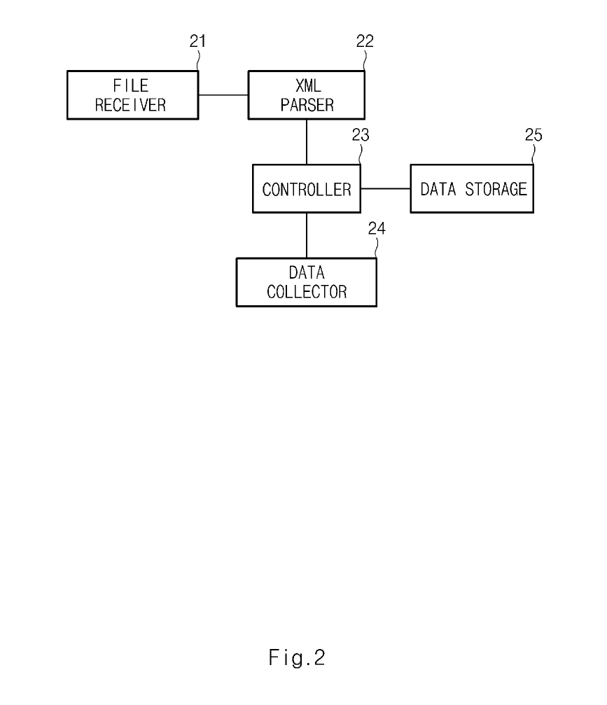

FIG. 2 is a configuration diagram of a vehicle data collecting apparatus according to an exemplary embodiment of the present disclosure.

As shown in FIG. 2, the vehicle data collecting apparatus according to an exemplary embodiment of the present disclosure includes a file receiver 21, an XML parser 22, a controller 23, a data collector 24, and a data storage 25.

The file receiver 21 provides an interface between the vehicle data collecting apparatus 20 and the managing server 10, and particularly, receives the XML script file from the managing server 10 in the push scheme.

The XML parser 22 parses the XML script file received by the file receiver 21. That is, the XML parser extracts data format information for each vehicle model and vehicle network by parsing the XML script file.

The controller 23 controls the data collector 24 so as to collect the vehicle data based on the data format information extracted by the XML parser 22. In this case, the controller 23 selects the data format matched to information of the vehicle (the vehicle model and network information) from the data format for each vehicle model and vehicle network.

The data collector 24 collects the vehicle data under a control of the controller 23. Here, the vehicle data includes an ignition key state, an engine speed sensor failure state, a fuel injection stop state, a torque calibration state, an air conditioner compressor activation state, an engine torque ratio, an engine speed, a vehicle speed, and the like.

In addition, the controller 23 stores version information of the XML script file received by the file receiver 21 in the data storage 25 so that the version information may be used for confirming a version at the time of upgrading the XML script file.

The data storage 25 stores the version information of the XML script file received by the file receiver 21 through the controller 23.

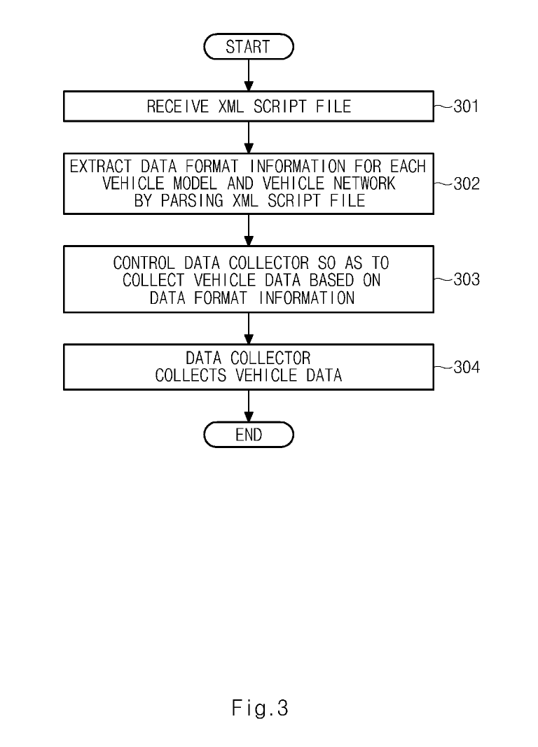

FIG. 3 is a flow chart of a vehicle data collecting method according to an exemplary embodiment of the present disclosure. The file receiver 21 receives the XML script file from the managing server 10 at step 301. Then, the XML parser 22 extracts data format information for each vehicle model and vehicle network by parsing the XML script file received by the file receiver 21 at step 302.

The controller 23 controls the data collector 24 so as to collect the vehicle data based on the data format information extracted by the XML parser 22 at step 303. The data collector then collects the vehicle data by the controller 23 at step 304.

As set forth above, the present disclosure may flexibly collect the vehicle data regardless of the data format which depends on a vehicle model and vehicle network, by collecting the vehicle data based on the script file having the XML type.

The present disclosure described above may be variously substituted, altered, and modified by those skilled in the art to which the present disclosure pertains without departing from the scope and sprit of the present disclosure. Therefore, the present disclosure is not limited to the above-mentioned exemplary embodiments and the accompanying drawings.

What is claimed is:

1. A vehicle data collecting apparatus, comprising:
a file receiver for receiving an extensible markup language (XML) script file;
an XML parser for extracting data format information for each vehicle model and vehicle network by parsing the XML script file received by the file receiving unit;
a controller configured to control a data collector so as to collect vehicle data based on the data format information extracted by the XML parser; and
the data collector for collecting the vehicle data under control of the controller.

2. The vehicle data collecting apparatus according to claim 1, further comprising a data storage, wherein the controller further performs a function of storing version information of the XML script file in the data storage.

3. The vehicle data collecting apparatus according to claim 1, wherein the controller selects the data format matched to vehicle information, including vehicle model and network information, from the data format for each vehicle model and vehicle network.

4. The vehicle data collecting apparatus according to claim 1, wherein the file receiver receives the XML script file in a push scheme.

5. A managing server, comprising:
a script file generator for generating a script file based on vehicle network information and vehicle model information;
an extensible markup language (XML) transformer for transforming the script file generated by the script file generator into an XML script file; and
a file transmitter for transmitting the XML script file transformed by the XML transformer to a vehicle data collecting apparatus.

6. The managing server according to claim 5, wherein the file transmitter transmits the XML script file in a push scheme.

7. The managing server according to claim 5, wherein the vehicle network information includes at least one of a controller area network (CAN) of a database for CAN format, a local interconnect network (LIN) of a LIN description files format, and a FlexRay of a field bus exchange format.

8. A vehicle data collecting system, comprising:
a managing server for generating a script file based on vehicle network information and vehicle model information and then transforming the script file into an extensible markup language (XML) file to generate an XML script file; and
a vehicle data collecting apparatus for extracting information for a data format for each vehicle model and vehicle network by parsing the XML script file generated by the managing server and then collecting vehicle data based on the extracted information.
